(19) United States
(12) Patent Application Publication
(10) Pub. No.: US 2026/0329002 A1
(43) Pub. Date: Oct. 22, 2026

(54) STRUCTURE FOR A PHOTONIC INTEGRATED CIRCUIT

(71) Applicant: SMART PHOTONICS HOLDING B.V., Eindhoven (NL)

(72) Inventor: Erik DEN HAAN, Eindhoven (NL)

(21) Appl. No.: 19/699,594

(22) Filed: Jun. 5, 2026

Related U.S. Application Data
(63) Continuation of application No. PCT/EP2024/084853, filed on Dec. 5, 2024.

(30) Foreign Application Priority Data
Dec. 7, 2023 (GB) 2318730.5

(51) Int. Cl. G02B 6/122; G02B 6/13

(52) U.S. Cl. CPC G02B 6/122; G02B 6/13

(57) ABSTRACT

A structure for a photonic integrated circuit comprising a substrate, a semiconductor waveguide, and a metal layer. The semiconductor waveguide is on a first portion of the substrate, the first portion between a second portion of the substrate and a third portion of the substrate, a length of the semiconductor waveguide corresponding with a light propagation axis between a first end of the semiconductor waveguide and a second end of the semiconductor waveguide. The metal layer spans between the second portion and the third portion of the substrate and is configured to at least partially enclose the semiconductor waveguide between the metal layer and the first portion of the substrate substantially along the length of the semiconductor waveguide.

### CROSS-REFERENCE TO RELATED APPLICATIONS

This application is a continuation under 35 U.S.C. § 120 of International Application No. PCT/EP2024/084853, filed Dec. 5, 2024 which claims priority to United Kingdom GB Application No. 2318730.5, filed Dec. 7, 2023, under 35 U.S.C. § 119(a). Each of the above-referenced patent applications is incorporated by reference in its entirety.

### BACKGROUND

Photonic integrated circuits comprising semiconductor waveguides for controlling the propagation of light are known. Optical properties of the semiconductor waveguides can be affected by environmental factors. It is desirable to improve the performance of a semiconductor waveguide.

### BRIEF DESCRIPTION OF THE DRAWINGS

FIG. 1 shows schematically a plan view of a photonic integrated circuit comprising a structure according to examples;

FIGS. 2 and 3 show schematically front cross-sections of a structure according to examples;

FIG. 4 shows schematically a side cross-section of a structure according to examples;

FIGS. 5a-5d each illustrate schematically examples of side cross-sections of the structure during steps of manufacture, according to examples.

FIGS. 6a, 6b illustrate flowcharts describing steps for forming a structure according to examples.

### DETAILED DESCRIPTION

Examples described herein relate to a structure for a photonic integrated circuit (PIC). More specifically, examples described herein relate to a structure comprising a metal layer which functions as a barrier to reduce moisture ingress into a semiconductor waveguide. For brevity, the semiconductor waveguide may in the present disclosure be referred to as the waveguide.

Optical properties of a waveguide, such as an optical path length of the waveguide, can be important in devices such as interferometers or lasers which are sensitive towards, and utilise, optical interference effects. In such devices, the optical path length of constituent waveguides can be important in determining a cavity length or a path length difference, for example, such that a resonance condition is met for a particular wavelength of light guided in the waveguide. Similarly, non-linear processes can rely on phase-matching conditions which are dependent on precise refractive index values.

Moisture ingress can alter a material refractive index of the waveguide and hence an effective refractive index of a guided mode of the waveguide. As used herein, a waveguide can be understood to comprise layers which give rise to, or support, a guided optical mode. Moisture ingress into the waveguide can comprise moisture ingress into any of a core layer of the waveguide, a cladding layer or cladding layers of the waveguide, or into any other layer or layers whose presence may modify the effective refractive index of a guided optical mode compared with said layers being absent. Accordingly, the optical path length for light propagating through a waveguide for which no moisture ingress has occurred may have a different optical path length compared to the same waveguide which has experienced moisture ingress. This can disrupt the performance of a device comprising the waveguide by, for example, preventing a resonance condition from being met for the particular wavelength of light guided in the waveguide. Similarly, a phase-matching condition may be prevented by modification of the material refractive index or effective refractive index of a guided mode of the waveguide. Such moisture ingress typically occurs due to humidity in the environment surrounding the waveguide or photonic integrated circuit more generally.

The aforementioned problems can be avoided or mitigated by preventing or reducing moisture ingress into the waveguide.

One known approach can be to use dielectric layers to coat the waveguide and protect against moisture ingress. However, it is an observation of the inventors that, in spite of these layers, moisture ingress through these layers can still occur to a degree which impacts the optical performance of the waveguide.

The following description of examples relate to a structure for a photonic integrated circuit. The structure comprises a substrate; a semiconductor waveguide on a first portion of the substrate, the first portion between a second portion of the substrate and a third portion of the substrate, a length of the semiconductor waveguide corresponding with a light propagation axis between a first end of the semiconductor waveguide and a second end of the semiconductor waveguide; and a metal layer spanning between the second portion and the third portion of the substrate and configured to at least partially enclose the semiconductor waveguide between the metal layer and the first portion of the substrate substantially along the length of the semiconductor waveguide.

The semiconductor waveguide of the structure can be shielded from moisture ingress by a barrier formed of the metal layer. The metal layer, in spanning across the waveguide from positions of the substrate either side of the waveguide such that the waveguide is between the metal layer and the substrate, and extending substantially along the length of the waveguide, can be considered to enclose and form a barrier for a substantial portion of the waveguide, and thereby prevent or reduce moisture ingress for a substantial portion of the semiconductor waveguide. Extending substantially along the length of the waveguide, as used in the present and other examples described herein, can refer to, for example, all of the length of the waveguide, or a majority of the length of the waveguide, such as along more than 75% or 90% of the waveguide, for example. A substantial portion of a layer, such as of the semiconductor waveguide, as used in the present and other examples described herein, can mean, for example, a majority or all of the layer, such as a majority of the volume of the layer, a majority of an area of the layer, or a majority of the length of the layer, for example. The waveguide, in experiencing reduced moisture ingress, can improve optical properties such as lower optical propagation loss or better stability of optical properties, in that the optical properties, such as the optical path length of the waveguide, do not change, or change less, with time.

In examples, the structure further comprises at least one layer between the semiconductor waveguide and the metal layer and along the length of the semiconductor waveguide. Such a layer can function as a passivation layer, for example, and in some examples a plurality of such layers may be provided between the semiconductor waveguide and the metal layer. The at least one layer may enhance the performance of the waveguide or provide some other functionality within the photonic integrated circuit, for example. The metal layer can shield the at least one layer from moisture ingress which, for example, could subsequently ingress into the semiconductor waveguide, and/or could be detrimental to the function of the at least one layer. In some examples, the at least one layer extends along a partial length of the semiconductor waveguide from a first end of the at least one layer to a second end of the at least one layer, and the metal layer encloses the at least one layer such that the at least one layer is surrounded by at least one of the semiconductor waveguide or the metal layer. This can decrease the risk of moisture ingress into the at least one layer.

In examples, an interfacing layer is provided between the substrate and the metal layer. The interfacing layer can help the metal layer adhere to the substrate, for example. The interfacing layer can, additionally or alternatively, prevent or reduce diffusion of materials of the metal layer into the substrate.

In examples, an intermediate layer is provided between the metal layer and the semiconductor waveguide, and configured to prevent diffusion of material from the metal layer into the semiconductor waveguide. Diffusion of material from the metal layer into the semiconductor waveguide can reduce optical performance of the semiconductor waveguide, for example by increasing optical loss of light propagating through the semiconductor waveguide.

In examples, the metal layer extends no further than 10 microns from the semiconductor waveguide in a lateral direction perpendicular to the light propagation axis. In this way, the barrier can be provided on and in regions within 10 microns of the waveguide, as opposed to covering the entire PIC. This can reduce an amount of material required to form a barrier for the waveguide, for example. Covering the entire PIC can additionally be an inefficient use of materials as material is wasted coating areas which might not need to be coated. Covering the entire PIC as a globally-applied barrier may otherwise electrically short-circuit the active device or electrically disrupt its performance, for example. Arranging electrical contacts with such a global barrier can require extensive post-processing fabrication steps which slow an overall manufacture process. However, when the metal layer is confined to the waveguide and regions proximal to the waveguide, for example, such as within 10 microns of the waveguide, a risk of disrupting nearby components of the PIC can be reduced, and can simplify arranging electrical contacts with active components of the PIC, for example.

An insight of the inventors is that, in examples, the barrier can be formed using materials which are otherwise used to form electrical contacts for active devices of the photonic integrated circuit and in a same stage of fabrication of the photonic integrated circuit. This can simplify fabrication of the photonic integrated circuit relative to forming the barrier from other types of materials and/or at a different stage of fabrication. In this way, the fabrication of the structure described herein can be integrated into pre-existing methods of PIC fabrication. A further insight of the inventors is that traditional passivation layers, which may provide some environmental protection, may be inadequate at protecting from moisture for use in devices which are particularly sensitive to optical properties of the constituent waveguides, because moisture ingress still occurs at a level which is disruptive to the performance of the device.

As used in the description of examples herein, the extension of a first layer substantially along the length of a second layer can mean, for example, the extension of the first layer along a majority of the length of the second layer. For example, the extension of a layer substantially along the length of the semiconductor waveguide can mean along a majority of the length of the semiconductor waveguide, in examples including the entirety of the length of the semiconductor waveguide, and in examples having a length longer than the length of the semiconductor waveguide. As used herein, extension of a layer from A to B can mean that the layer terminates at A and B when considered in a direction between A and B, for example.

Examples of the present disclosure will now be described in view of the figures.

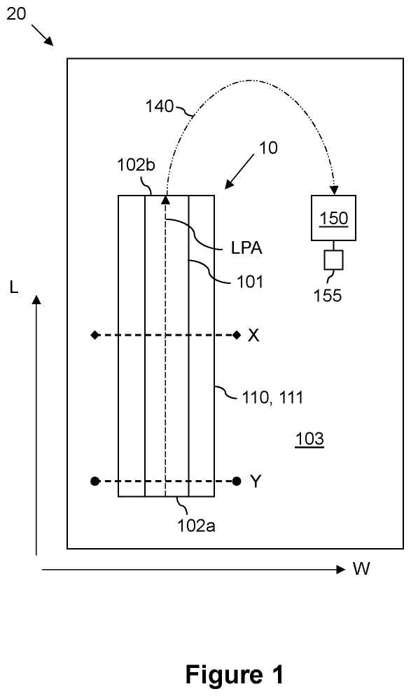

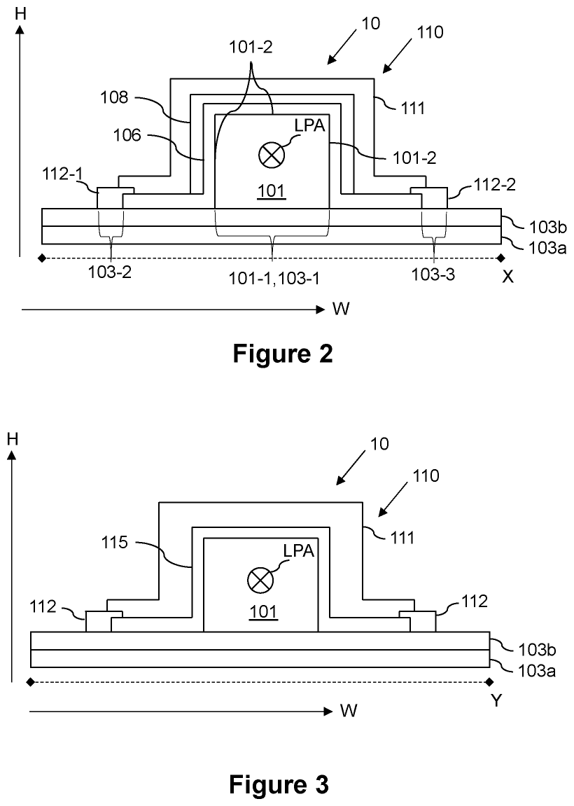

FIG. 1 illustrates schematically, in plan-view, a structure 10 for a photonic integrated circuit 20. The structure 10 comprises: a substrate 103, a waveguide 101, and a metal layer 111. FIGS. 2 and 3 illustrates the structure 10 in cross-sectional views. The cross-sectional view of FIG. 2 is taken along the indicative line X of FIG. 1, and illustrates the cross-section of the structure 10 at a midway position of the structure 10. The cross-sectional view of FIG. 3 is taken along the indicative line Y of FIG. 1, and illustrates the cross-section of the structure 10 at an end 102a of the structure 10.

The plan-view of FIG. 1 is in a plane parallel to light propagation axis LPA of the waveguide 101. The light propagation axis LPA of the waveguide 101 is depicted as extending parallel to a first axis L, which can be considered a length axis. The waveguide 101 has a width which extends parallel to a second axis W, which can be considered a width axis. The cross-sectional views of FIGS. 2 and 3 are in a plane perpendicular to the light propagation axis LPA of the waveguide 101. The waveguide 101 has a height which extends parallel to a third axis H, which can be considered a vertical axis. The skilled person will understand that the first to third axes L, W, H, which may be referred to collectively as reference axes L, W, H, define a local reference frame and that the positional description of features are implicitly with respect to this local reference frame, unless explicitly stated otherwise. Furthermore, the local reference frame can be mapped to some other reference frame. For example, a first element being described as “above” a second element with respect to references axes L, W, H is still valid even if the PIC 20 or structure 10 is rotated in some other reference frame.

The structural arrangement of the structure 10, in view of the examples illustrated in FIGS. 2-4, will now be described.

The structure 10 comprises a substrate 103. In examples, the substrate 103 is a substrate plane of the PIC 20. In other words, the substrate 103 is a wafer substrate upon which the PIC 20 is formed. The substrate 103 is substantially planar and extends substantially in the horizontal plane, wherein substantially planar means planar within manufacturing capabilities or acceptable manufacturing tolerances, for example. That is, an upper surface of the substrate 103 is substantially parallel with plane of width axis W and length axis L. The substrate 103 can be considered to form a base for the structure 10, such that other components described hereafter can be considered to be above the substrate 103, with respect to the vertical axis H. In the example illustrated by FIGS. 2, 3, the substrate comprises a first layer 103a and a second layer 103b. The first layer 103a is the underlying substrate plane of the PIC 20. The second layer 103b is an intermediate substrate layer which is disposed on and parallel to the first layer 103a.

The structure 10 comprises a waveguide 101 which is a semiconductor waveguide formed from semiconductor materials, though referred to hereafter simply as a waveguide 101. The waveguide 101 extends by a length from a first end 102a to a second end 102b. The waveguide 101 comprises, extending from the first end 102a to the second end 102b, a first surface 101-1 which is in contact with a first portion 103-1 of the substrate 103. The waveguide 101 comprises, extending from the first end 102a to the second end 102b, a second surface 101-2 which is not in contact with the substrate 103. In other words, the first surface 101-1 can be considered to be the bottom of the waveguide 101 in contact with the substrate 103, and the second surface 101-2 comprises the remaining sides of the waveguide 101 which are not in contact with the substrate 103. The second surface 101-2, in comprising the sides which are not in the contact with the substrate 103, can be considered the external surface of the waveguide 101. The first portion 103-1 can, correspondingly, be considered the portion of the substrate 103 upon which the waveguide is disposed. The combination of the first surface 101-1 and second surface 101-2 define, in a plane perpendicular to the light propagation axis LPA, a cross-sectional geometry of the waveguide 101. The waveguide 101 generally comprises a core layer into which the majority of light propagating in a guided mode may be confined, and in examples may comprise a cladding layer or a plurality of cladding layers between which the core layer is arranged, and which can be understood to further help support the guided mode. It will be understood that the configuration of core and cladding can vary between examples, and that the precise configuration of the core and any cladding layers of the waveguide 101 is immaterial to the present disclosure, and so the constituent core and cladding layers are not explicitly illustrated here.

The structure 10 of FIGS. 2-4 comprises a first further layer 106. The first further layer 106 is a continuous, conformal layer which, in the cross-sectional plane perpendicular to the light propagation axis of the waveguide 101, is disposed on the second surface 101-2 of the waveguide. That is, the first further layer 106 is in contact with the top of the waveguide 101 in the vertical direction and with either side of the waveguide 101 in the horizontal direction. The first further layer 106 contacts the substrate 103 either side of the waveguide 101 such that the first further layer 106 and substrate 103 thereby envelop, in the cross-sectional plane perpendicular to the light propagation axis of the waveguide 101, the waveguide 101. In this example, the first further layer 106 extends along a partial length of the waveguide 101. In this example, the partial length is a majority of the length of the waveguide 101, and the first further layer 106 is absent in a first region proximal the first end 102a and in a section region proximal the second end 102b. The first further layer 106 is therefore present in FIG. 2, which illustrates a cross-section of midway position of the structure 10, but is absent from FIG. 3, which illustrates a cross-section nearer an end of the structure 10. In other examples, the structure 10 may not comprise a first further layer 106.

The structure 10 of FIGS. 2-4 comprises a second further layer 108. Similar to the first further layer 106, the second further layer 108 is also a continuous, conformal layer and, in the cross-sectional plane perpendicular to the light propagation axis of the waveguide 101, is disposed on top of the first further layer 106 in the vertical direction and along a portion of either side of the first further layer 106. In this example, the second further layer 108 does not contact the substrate. The second further layer 108 also extends a long a partial length of the waveguide 101, extending in this example by a majority of the length of the waveguide 101, and being absent from the first region proximal the first end 102a and the second end 102b. Similarly to the first further layer 106, the second further layer 108 is present in FIG. 2 and absent from FIG. 3. In other examples, the structure 10 may not comprise a second further layer 108.

The terms “first” and “second”, in the context of further layers 106, 108 described herein, are used as convenient labels and the presence of a second further layer 108 does not necessitate the existence of a first further layer 106 and/or vice versa.

The structure 10 comprises a barrier 110, which in the examples of FIGS. 2-4 is formed from a metal layer 111, interfacing layers 112, and an intermediate layer 115. Other compositions of the barrier 110 are possible and will be described later. As described above, the waveguide 101 is on the first portion 103-1 of the substrate 103. The first portion 103-1 of the substrate is between a second portion 103-2 of the substrate 103 and a third portion 103-3 of the substrate 103, when viewed in the cross-sectional plane perpendicular to the light propagation axis of the waveguide 101. The waveguide 101 is not in contact with the second portion 103-2 and the third portion 103-3 of the substrate. The metal layer 111, and more generally the barrier 110, spans between the second portion 103-2 of the substrate 103 to the third portion 103-3 of the substrate 103. Spans, as used in the present and other examples described herein, means for example that the metal layer 111 extends from the second portion 103-2 of the substrate 103, over the waveguide 101, to the third portion 103-3 of the substrate 103, in a continuous manner. In other words, the metal layer 111 bridges, or passes over, the waveguide 101, from the second portion 103-2 of the substrate 103 to the third portion 103-3 of the substrate 103. In other words, the waveguide 101 can be considered to be disposed on the substrate 103 and covered, along the length of the waveguide, by the barrier 110 formed of the metal layer 111, and in examples with the interfacing layers 112 and/or the intermediate layer 115.

In the example of FIGS. 2-4, a first interfacing layer 112-1 is in contact with the second portion 103-2 of the substrate, and a second interfacing layer 112-2 is in contact with the third portion 103-3 of the substrate. In other words, the interfacing layers are arranged on either side of the waveguide, in the aforementioned cross-sectional plane. The interfacing layers 112 extend along the length of the waveguide 101, also extending from the first end 102a to the second end 102b. In other examples, interfacing layers 112 may not be present.

The metal layer 111 extends substantially along the length of the waveguide 101. As described earlier, extending substantially along means the metal layer 111 extends along a majority of the waveguide, for example, or at least 75%, or at least 80%, or at least 90% of the length of the waveguide, for example, and in examples extends entirely along the length of the waveguide, that is 100% of the length of the waveguide. The metal layer 111 is disposed on and in contact with top portions of the interfacing layers 112-1, 112-2. The interfacing layers 112-1, 112-2 are thereby between and in contact with the substrate and the metal layer. The metal layer 111 of the examples of FIGS. 2-4 is, in the cross-sectional plane perpendicular to the light propagation axis of the waveguide 101, a continuous, conformal layer which is disposed onto the second further layer 108 and extends from the first interfacing layer 112-2, over the waveguide 101, first further layer 106, and second further layer 108, to the second interfacing layer. Considering the second surface 101-2 of the waveguide, the second surface 101-2 is, in a direction perpendicular to the first surface 101-1, or the underlying substrate 103, between the metal layer and the substrate. The metal layer 111 thereby at least partially encloses the waveguide 101 between the metal layer 111 and the substrate. As used herein, at least partially encloses can refer to an arrangement where at least part of the waveguide is between portions of the metal layer and the substrate layer, the substrate layer and the substrate layer, or the metal layer and the metal layer. In a direction perpendicular to the light propagation axis, such as the cross section illustrated by FIG. 2, the metal layer 111, interfacing layer 112 and the substrate layer together form a boundary around the waveguide, such that the waveguide 101 can be considered to be entirely enclosed by the metal layer and the substrate layer within the plane of this cross section.

The waveguide 101, first further layer 106, and second further layer 108 are thereby enveloped by the barrier 110, comprising the interfacing layers 112 and metal layer 111, and the underlying substrate 103, in the cross-sectional plane perpendicular to the light propagation axis of the waveguide 101.

In the examples of FIGS. 2-4, at the ends of the structure 10, such as illustrated by the cross-section in FIG. 3, the first further layer 106 and second further layer 108 are absent. Instead, in the examples of FIGS. 2-4 an intermediate layer 115 is provided in the corresponding position to the absent first further layer 106 and second further layer 108. That is, the intermediate layer 115 is disposed on the substrate either side of the waveguide 101, and forms a continuous, conformal layer around the external surfaces 101-2 of the waveguide 101 to thereby, in combination with the substrate 103, envelop the waveguide 101 in the cross-sectional plane perpendicular to the light propagation axis of the waveguide 101. In other examples, the intermediate layer 115 may not be present.

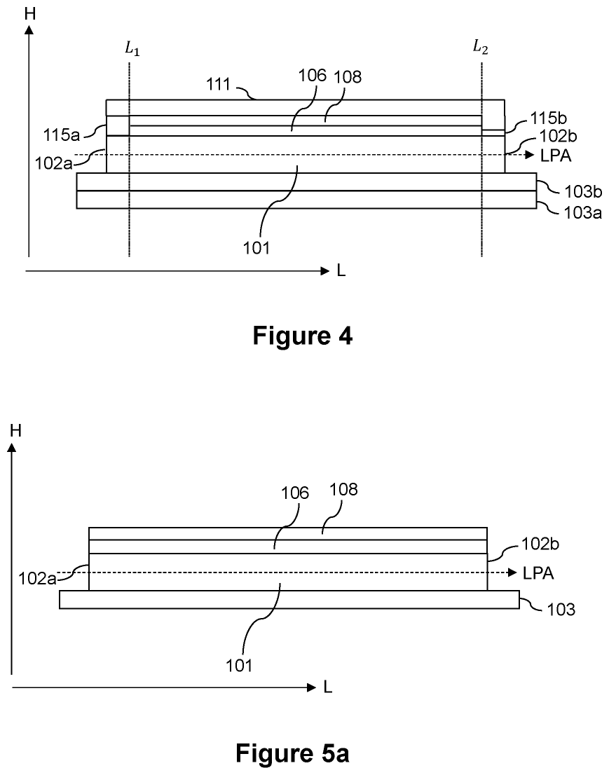

FIG. 4 illustrates the structure 10 in a side cross-sectional view, such that the light propagation axis is parallel to the plane along which the cross-section is taken. In FIG. 4, the first further layer 106 and second further layer 108 can be seen to extend between a point L₁ near the first end 102a of the waveguide 101 and a point L₂ near the second end 102b of the waveguide 101. The first further layer 106 and second further layer 108 thereby extend along a partial length of the waveguide 101, wherein the partial length is a substantial length, such as a majority of the length, of the waveguide 101, such as at least 80% of the length of the waveguide, and e.g. at least 95% of the length of the waveguide. Two variations of the intermediate layer 115 are illustrated here for explanatory purposes. At point L₁, the intermediate layer 115a fills the entire absent portion between the waveguide 101 and the metal layer 111, the intermediate layer 115a being the same height, relative to the vertical axis H, as the combination of the first further layer 106 and the second further layer 108. At point L₂, the intermediate layer 115b fills a partial region of the absent portion between waveguide 101 and the metal layer 111, the intermediate layer 115a being a portion of the height, relative to the vertical axis H, as the combination of the first further layer 106 and the second further layer 108. At the point L₂, the metal layer 111 extends downwards, towards the intermediate layer 115, to fill the remaining absent portion. The absent portion may be around 10 microns in length, though may be shorter if fabrication allows, for example down to 5 microns.

The first further layer 106 and second further layer 108 are thereby encapsulated, in the examples of FIGS. 2-4, by the metal layer 111, interfacing layers 112, intermediate layer 115 and waveguide 101. In other words, the first further layer 106 and second further layer 108 are in all directions surrounded by at least one of the waveguide 101 or the barrier 110. That is, the barrier 110 shields the first further layer 106 and the second further layer 108 from the surrounding environment, because all external surfaces of the first further layer 106 and second further layer 108 are in contact with at least one of the metal layer 111, interfacing layers 112, intermediate layer 115, and waveguide 101.

Similarly, it will be appreciated that, in the examples of FIGS. 2-4, the only surfaces of the waveguide 101 which are not surrounded by the barrier 110 are input and output facets present at the first end 102a and the second end 102b of the waveguide 101, which generally interface with neighbouring components of the photonic integrated circuit 20.

Having described the structural arrangement of the structure 10 and the constituent elements thereof, the function of the constituent elements will now be described.

The waveguide 101 is for guiding light. Properties of a waveguide including, for example, its material refractive index and structural geometry, as well as properties of any surrounding cladding layers, restrict the spatial region in which light can propagate, for example the waveguide core layer. Particular optical modes of light are desired to propagate through the waveguide 101 depending on the desired application of the structure 10. The direction in which the optical modes propagate within the waveguide 101 is herein referred to as the light propagation axis LPA. The light propagation axis LPA is parallel to the Poynting vector of light propagating in the waveguide 101 and the negative vector of the Poynting vector. The light propagation axis LPA is the general direction which the energy of the optical mode travels through the waveguide 101. The term “modes” as used herein refers to optical modes, which may be considered to be electromagnetic propagation modes. The modes of a particular waveguide may be described herein as being “supported” by the waveguide.

The waveguide 101 comprises indium gallium arsenide phosphide (InGaAsP). For example, the waveguide can be bulk indium gallium arsenide phosphide lattice-matched to the underlying InP substrate. In other examples, though, the waveguide 101 comprises or is of indium aluminium gallium arsenide (InAlGaAs). More generally, in some examples, the waveguide 101 comprises (Al)InGaAs(P). In other examples, the waveguide may comprise silicon and/or silicon nitride compositions. The elements indicated in parentheses can be interchangeable and the composition of the different elements is selected depending on the desired function. For example, the composition of Ga and As in InGaAs can be selected according to the desired bandgap. In other examples, the waveguide core comprises a plurality of sub-layers. In some such examples, the waveguide core comprises a (Al)InGaAs(P)/(Al)InGaAs(P) multiple quantum well structure. In some examples, the sub-layers are between 5 and 30 nanometres thick. The bandgap and therefore, as will be appreciated by those skilled in the art, the refractive index of the InGaAsP, for example, can be tuned. In some examples, the bandgap of the InGaAsP of the waveguide core layer is tuned to a wavelength of 1250 nanometres (e.g. for propagation of light of wavelength 1550 nanometres) or 1100 nanometres (e.g. for propagation of light of wavelength 1310 nanometres). In other examples, the wavelength to which the bandgap is tuned is different.

A mode supported by the waveguide 101 can be considered to have an effective refractive index which arises from a combination of the structural geometry of the waveguide 101 and the material refractive index, or indices, of the constituent core and cladding layers. The effective refractive index of a mode determines the rate of propagation of light through the waveguide 101 in that particular mode. Modification of the effective refractive index changes the optical path length of the waveguide 101. As those skilled in the art will appreciate, the optical path length OPL for a path of geometrical length l in a medium of constant refractive index n is given by:

OPL=nl

and, accordingly, a change in the refractive index will alter the optical path length of a waveguide even when the geometrical length l remains unchanged.

The first and second further layers, if present, can serve different purposes, or may contribute to a same purpose, and in general represent other layers of the semiconductor structure which may be provided between the waveguide 101 and the barrier 110. The examples illustrated by figures herein depict how such layers can be accommodated by the barrier 110. For example, the further layers or further layer may ordinarily, in other semiconductor structures without the barrier 110, be provided to perform functions such as protecting the waveguide 101 from moisture ingress and/or corrosion due to the external environment around the structure 10. These functions may be performed by either or both of the further layers, or by just a single further layer, or by three or more further layers, for example. Each further layer 106, 108 may itself comprise a plurality of sublayers, for example an inner sublayer which is closer to the waveguide 101 and has a reduced impact on the optical properties of the waveguide 101, and an outer sublayer which is further from the waveguide 101 and is more resilient to the external environment around the structure 10. Further layers may also be provided to negate dangling bond defects at the surface of the waveguide 101 which can otherwise increase optical absorption of the waveguide 101, thereby decreasing optical performance of the waveguide 101, and can also increase current leakage through the waveguide 101. Some further layers may not be related to the optical function of the waveguide, for example: the second further layer 108 can be used for improving the planarity of a top surface of the photonic integrated circuit 20. It is an observation of the inventors that, at least in applications which are particularly sensitive to the optical properties of constituent waveguides, further layers provided on or around the waveguide may offer little to protect the waveguide 101 from moisture ingress. The further layers may comprise semiconductor or dielectric materials, for example. The first and/or second further layers may each, or in combination, function as a passivation layer, for example.

In general, the metal layer 111 which forms the barrier 110 is for acting as a barrier to moisture. More generally, the other features which combine with the metal layer 111 may also act as a barrier to moisture. That is, the metal layer 111, interfacing layers 112, and intermediate layer 115 may each be formed from a respective material which has a lower moisture permeability than, for example, the first further layer 106 or the second further layer 108 which might otherwise form the external surface of the photonic integrated circuit 20. The skilled person will understand that moisture permeability refers to water vapor diffusion through a unit of surface area of a material. Larger moisture permeability corresponds to allowing more moisture through a surface area of the material, whilst lower moisture permeability corresponds to allowing less moisture through a surface area of the material.

The metal layer 111 of the barrier 110, in the examples of FIGS. 2-4, is formed from a gold plating. The gold plating is on the order of 2-3 microns thick which can form a particularly efficient water barrier, though in other examples the metal layer 111 may be thinner, for example 200 nanometres, or 200 nanometres to 2 microns, or thicker, for example between 3 to 5 microns, or up to 10 microns, depending on the level of moisture protection desired, for example.

The interfacing layer 112 of the barrier 110, in the examples of FIGS. 2-4, is formed from a material which facilitates adhesion and alloy formation with the substrate 103b. The interfacing layer may be referred to as a buffer layer, or a bridging layer, for example. In the examples of FIGS. 2-4, the first substrate layer 103a is formed of indium phosphide and the second substrate layer 103b is formed from n-doped indium phosphide and so can function as an electrical ground plane. If the metal layer 111 is placed directly in contact with the substrate, diffusion of the metal of the metal layer 111 may occur into the substrate 103. This may reduce performance of the substrate 103b and surrounding structures of the PIC by altering the optical or electronic properties of the substrate layer. The interfacing layer 112 can act to reduce or prevent this whilst allowing the metal layer 111 to adhere to the substrate.

In other examples, the interfacing layers 112, if present, may more generally provide improved connection between the barrier 110 and the substrate 103 such as providing a chemical adhesion between the two.

The intermediate layer 115 may be formed from an alloy, and generally may be formed from a material different to that of the metal layer 111, for example. As described previously, at the end portions of the waveguide 101 (the portions corresponding with points L₁ and L₂) the first further layer 106 and the second further layer 108 are absent. To form a water barrier, it is therefore desirable to fill the absent portions. However, where gold plating is used, for example, there may be a risk of diffusion of gold particles into the waveguide 101 which can detrimentally impact the optical properties of the waveguide 101, such as increasing absorption or modifying the refractive index. The intermediate layer 115 can be formed of a metal material which can prevent or reduce diffusion of the gold particles into the waveguide 101 whilst contributing towards the water barrier function of the barrier 110. In the example of FIGS. 2 and 3, this absent portion is short relative to the overall length of the waveguide 101, such as being around 10 microns in length, and e.g. down to 5 microns in length where fabrication methods allow, as reducing the length of the intermediate layer 115 can reduce absorption of light in the waveguide 101.

Whilst the barrier 110 has been described as being formed from distinct layers comprising a metal layer 111, interfacing layer 112, and intermediate layer 115, it will be appreciated that in the described examples these layers are all formed from a metal or mixture of metals such that, more generally, the barrier 110 can be considered to form a conformal coating of metal across the waveguide 101 and in contact with the substrate 103, such that in examples there is a metal layer 111 which conformally seals the waveguide and surrounding layers where present to the substrate 103.

In the example of FIG. 1, the PIC 20 further comprises an active device 150 which is electronically addressable by electrical contacts 155. The electrical contacts 155 used to electronically address the active device 150, such as to power the active device 150 or read out from the active device 150, are formed from a conductive material such as gold. In examples, the material used to form the electrical contacts 155 is also used to form the barrier 110 and, as described later in relation to fabrication of the structure 10, the electrical contacts 155 and the barrier 110 may be formed as part of a single fabrication stage or step. In examples, therefore, an upper surface of the barrier 110, as considered relative to the vertical axis H, may be coplanar with electrical contacts 155 of the active device 150 to provide an overall planar surface of the PIC 20.

An optical path 140 comprising, for example, further waveguides connect the waveguide 101 of the structure 10 to the active device 150 such that light transmitted along the waveguide 101 can be received by the active device 150. For example, the active device 150 can, in examples, be a lasing portion of a laser, and the structure 10 form a cavity of the laser. In other examples, the active device 150 might be a photodetection element, and the structure 10 forming an interferometer. In this way, the active device 150 may benefit from improved performance as the structure 10 is improved by the presence of the barrier 110. It will be understood that, in some examples, the structure 10 may have no functional relation to the active device 150, but the electrical contacts 155 of the active device 150 are formed at the same time as the barrier 110, as described above. That is, in other examples, the active device 150 is separate from the structure 10 and no optical path between the two exists, and/or the active device 150 and structure 10 perform no particular function together, but nevertheless fabrication of the electrical contacts 155 and the structure 10 can be combined into a single fabrication stage or step.

The lateral extent of the barrier 110 and any of its constituent layers such as the metal layer 111, can be arranged to be physically separated from, or avoid coming into contact with, the active device 150 or electrical contacts 155 thereof. Lateral extent refers to the extent of the barrier 110 in a direction perpendicular to the light propagation axis of the waveguide 101 and parallel to the plane of the substrate 103. This can prevent the barrier 110 from interfering with the electrical contacts 155, for example by preventing or reducing a risk of short circuiting the electrical contacts 155. In other words, the barrier 110 is provided locally to the waveguide 101 rather than being deposited over substantially all of the photonic integrated circuit 10, wherein substantially all can mean over the majority of the photonic integrated circuit, and in examples can mean the entirety of the photonic integrated circuit. In this way, the PIC 20 may comprise regions comprising waveguides provided with such a metal layer, and regions with active devices which are separated from the metal layer. In examples, the lateral extent of the barrier 110 and any of its constituent layers such as the metal layer 111 is limited to 10 microns, which can allow for protection for moisture ingress whilst the footprint of the waveguide 101 and barrier 110 remains relatively compact. In examples where the footprint can be larger without interfering with other components of the PIC 20, the lateral extent can be limited to 15 microns, or 20 microns, or 25 microns, for example.

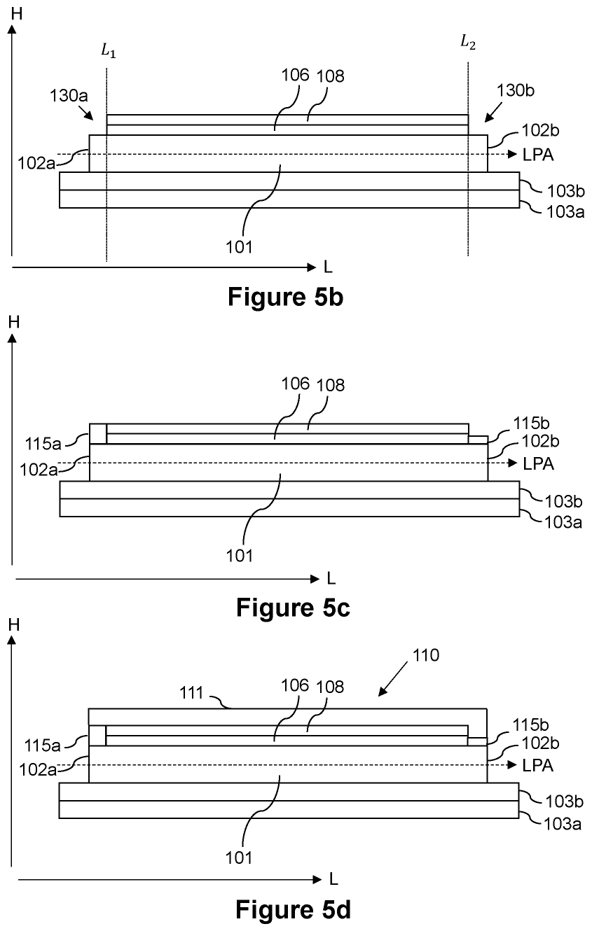

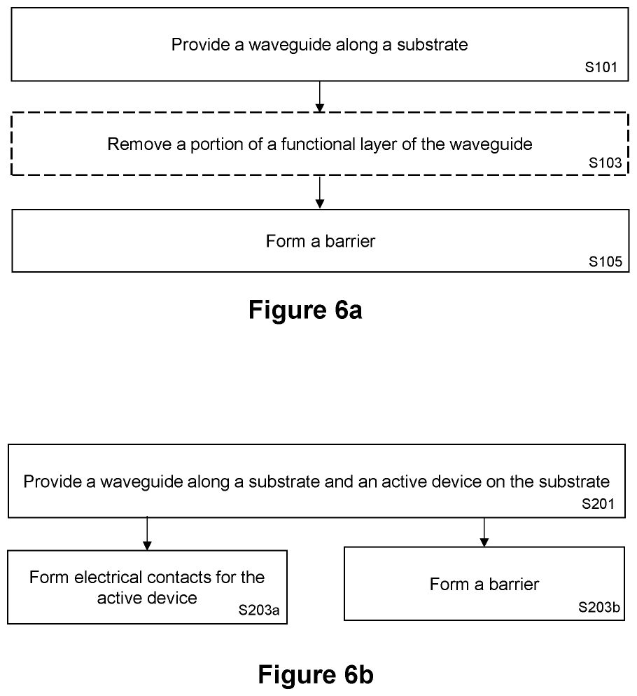

FIGS. 5a-5b illustrate, schematically, side-cross sections of the structure 10 during a fabrication process of the structure 10, for example to arrive at the structure 10 illustrated in the examples of FIGS. 2-4 and described previously. FIGS. 6a-6b depicts a flowchart detailing processes which can occur during fabrication of the structure 10.

At item S101 of FIG. 6a, a waveguide is provided along a substrate. The waveguide is in contact with a first portion of the substrate and extends by a length. FIG. 5a illustrates, schematically, an example of this, wherein a waveguide 101 is disposed on a first portion of a substrate 103 and extending from a first end 102a to a second end 102b. A light propagation axis LPA extends from the first end 102a to the second end 102b. A first further layer 106 and a second further layer 108 extend along the entire length of the waveguide 101, that is, also from the first end 102a to the second end 102b. The waveguide 101 provided at item S101, as well as the first further layer 106 and the second further layer 108, may have been previously fabricated in a separate fabrication process, for example, and the formation of the barrier 110 being performed at a later time, for example as a retrofitting process or post-processing stage.

As the skilled person will appreciate, various integrated photonic circuit fabrication techniques may be used to form the waveguide, first and second further layers, or substrate. For example, deposition, etching, and/or lithography may be used, and regrowth techniques such as metalorganic vapour-phase epitaxy (MOVPE) or molecular beam epitaxy (MBE) processes may be used. In some examples, the substrate material for the structure and/or photonic integrated circuit is InP. In some such examples, a wet etch procedure may be used in forming the waveguide and/or layer. In some such examples, a wet etch procedure is performed using HCl H3PO4:H2O. In some examples, a mixture of HCL, H3PO4 and H2O is used, which etches the desired material (in these examples, InP). In other examples, a mixture of HCL and H2O only is used as etchant. FeCl3 may also be used as an etchant. In examples, forming the waveguide and/or layer involves e.g. a dry etching procedure to remove material from either side of the structure, up to a particular depth as desired according to the intended application.

At item S103 of FIG. 6a, a portion of a functional layer of the waveguide is removed. A functional layer herein refers to, for example, the first further layer 106 or second further layer 108. FIG. 5b illustrates, schematically, an example of this, wherein the first further layer 106 and the second further layer 108 from the first end 102a to a point L₁ along the length are removed. Such a removal process can be by etching, for example. Item S103 may not occur, in that a functional layer may be present but nevertheless a portion of the functional layer is not removed, or a functional layer may not be present at all.

At item S105 of FIG. 6a, a barrier comprising a metal layer is formed. The barrier comprising the metal layer may be formed by sputtering, electroplating, electroless plating, or other deposition techniques, for example. As described previously, the barrier may comprise multiple constituent elements such as the metal layer, interfacing layers and intermediate layers. FIGS. 5c and 5d illustrate, schematically, an example of this. In FIG. 5c, an intermediate layer 115a, b is deposited onto the top surface of the waveguide 101. The intermediate layer 115a, b is formed in the absent region formed by the removal of the functional layer. As explained in view of FIG. 4, the intermediate layer may fill (intermediate layer 115a) the entire absent portion left by removal of the functional layers or may fill (intermediate layer 115b) a portion of the absent portion. In FIG. 5d, a metal layer 111 is formed on the intermediate layer 115a, b, as well as the functional layers. In other examples, there is no separate intermediate layer 115a, b, and the metal layer is formed in the absent portion.

FIG. 6b displays a flowchart comprising items used to form a PIC comprising the structure 10 described herein, as well as an active device, such as the example PIC 20 illustrated by FIG. 1.

At item S201, a waveguide and an active device are provided on a substrate of the PIC. The waveguide can be formed as per item S101, and the active device is similarly not restricted to any particular method of fabrication.

At item S203a, electrical contacts are formed for the active device and at item S203b, a barrier is formed by formation of a metal layer, for example as described at item S105 of FIG. 6a. These processes may take place simultaneously, for example, or as subsequent steps as part of a same fabrication stage. These steps can comprise depositing the same material down to form both the electrical contacts and the barrier. In examples, therefore, at the stage of forming electrical contacts for the active device of the PIC, a barrier for a passive waveguide of the PIC, for example, is simultaneously provided and formed from the same material, which can improve the speed of fabrication, for example, compared with forming them in separate steps.

Other configurations of the structure 10 are envisaged.

For example, an interfacing layer 112 may not be required, and instead the metal layer 111 directly contacts the substrate either side of the waveguide. Alternatively, a series of further interfacing layers may be provided.

For example, an intermediate layer 115 may not be required. The metal layer 111 may be formed of a material which has negligible, or tolerable, effects on the waveguide 101 when in direct contact with the waveguide 101. For example, the metal layer 111 may have a material composition which means diffusion of the material in the metal layer 111 into the waveguide 101 does not occur, or occurs at levels which are tolerable within the desired application of the structure 10.

For example, either, or both of, the first further layer 106 and second further layer 108 may not be present. The barrier 110 may instead be disposed directly onto the waveguide 101. For example, the barrier 110 may comprise a metal, or metal alloy, which does not exhibit, or exhibits tolerable levels of, diffusion of a constituent material into the waveguide 101.

For example, the first further layer 106 and second further layer 108 may each extend along the entire length of the waveguide 101 such that, at the first end 102a and the second end 102b of the structure 10, the first further layer 108 and the second further layer 106 are exposed to the external environment, similar to the input/output facet of the waveguide 101. Nevertheless, the waveguide 101 may be subject to less moisture ingress than having no such barrier along the length of the waveguide 101, for example.

For example, the waveguide 101 in FIGS. 2 and 3 is depicted as a linear waveguide, but the present disclosure can be equally applied to curved waveguides and other geometrical structures such as ring-resonators.

For example, the metal layer 111 and barrier 110 more generally has been described as comprising gold, but the skilled person will appreciate that in other examples, other metals may be used in addition to, or alternatively to, the examples described so far. In some examples, alloys may be used. In some example, other noble metals, or alloys comprising noble metals, may be used. Noble metals are conductive and can be generally unreactive, resilient to corrosion and have low moisture permeability. In some examples, a majority of the metal layer is formed from one material, such as gold. In other examples, the composition of the metal layer changes across the metal layer. For example, a first portion may comprise an alloy, for example a gold alloy, whereas another portion comprises a non-alloy such as a pure metal, such as pure gold.

The presence of the barrier formed of the metal layer has been described in terms of reducing moisture ingress into the waveguide which can improve optical performance of the waveguide. However, the skilled person will appreciate from the disclosure herein that any layers provided between the substrate and the metal layer may experience reduced moisture ingress, which can be beneficial for reasons beyond optical performance such as reasons related to improved electrical properties or improved structural properties, for example.

The above disclosure is to be understood as illustrative examples. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of this disclosure, and protected by the following claims.

1. A structure for a photonic integrated circuit, comprising:
a substrate;
a semiconductor waveguide on a first portion of the substrate, the first portion between a second portion of the substrate and a third portion of the substrate, a length of the semiconductor waveguide corresponding with a light propagation axis between a first end of the semiconductor waveguide and a second end of the semiconductor waveguide; and
a metal layer spanning between the second portion and the third portion of the substrate and configured to at least partially enclose the semiconductor waveguide between the metal layer and the first portion of the substrate substantially along the length of the semiconductor waveguide.

2. The structure of claim 1, wherein the metal layer comprises a noble metal.

3. The structure of claim 2, wherein the metal layer comprises gold.

4. The structure of claim 1 wherein the metal layer is formed of a material used to form electrical contacts for an active device of the photonic integrated circuit.

5. The structure of claim 1, wherein the structure further comprises at least one layer between the semiconductor waveguide and the metal layer and along the length of the semiconductor waveguide.

6. The structure of claim 5, wherein:
the at least one layer extends along a partial length of the semiconductor waveguide from a first end of the at least one layer to a second end of the at least one layer; and
the metal layer enclosing the at least one layer such that the at least one layer is surrounded by at least one of the semiconductor waveguide or the metal layer.

7. The structure of claim 5, wherein the at least one layer comprises a passivation layer.

8. The structure of claim 1, further comprising an intermediate layer between the metal layer and the semiconductor waveguide and configured to prevent diffusion of material from the metal layer into the semiconductor waveguide.

9. The structure of claim 1, wherein the metal layer is in contact with the second portion and the third portion of the substrate.

10. The structure of claim 1, further comprising an interfacing layer between the metal layer and the substrate, the interfacing layer in contact with the second portion and the third portion of the substrate and the metal layer.

11. The structure of claim 1 wherein the metal layer extends no further than 10 microns from the semiconductor waveguide in a lateral direction perpendicular to the light propagation axis.

12. The structure of claim 1 wherein the metal layer has a thickness of at least 2 microns.

13. A photonic integrated circuit comprising the structure of claim 1.

14. The photonic integrated circuit of claim 13, wherein the photonic integrated circuit comprises an optical interferometer, the optical interferometer comprising the structure.

15. The photonic integrated circuit of claim 13 wherein the photonic integrated circuit comprises an active device comprising electrical contacts formed from a metal, and the barrier structure of the structure is formed from the metal.

16. A method of manufacturing a structure for a photonic integrated circuit, the method comprising:
providing a semiconductor waveguide along a substrate, the semiconductor waveguide in contact with a first portion of the substrate and between a second portion and a third portion of the substrate; and
forming a metal layer over the semiconductor waveguide, the metal layer formed along a substantial length of the semiconductor waveguide and spanning between a second portion of the substrate and a third portion of the substrate to at least partially enclose the semiconductor waveguide between the metal layer and the first portion of the substrate.

17. The method of claim 16 further comprising forming an interfacing layer on the second portion of the substrate and the third portion of the substrate, and forming the metal layer on the interfacing layer.

18. The method of claim 16 wherein the waveguide comprises a passivation layer disposed on the semiconductor waveguide, the passivation layer extending along the length of the semiconductor waveguide; and
the method further comprising:
removing a first portion of the passivation layer such that the passivation layer extends along a partial length of the semiconductor waveguide; and
forming the metal layer in the position of the removed first portion.

19. The method of claim 18 further comprising forming an intermediate layer in the position of the removed first portion, the intermediate layer comprising a metal material.

20. The method of claim 16 wherein forming the metal layer comprises forming an electrical contact from a metal material for an active device of the photonic integrated circuit, and forming the metal layer using the metal material.
